(19) United States
(12) Patent Application Publication
(10) Pub. No.: US 2014/0281680 A1
(43) Pub. Date: Sep. 18, 2014

(54) DUAL DATA RATE BRIDGE CONTROLLER WITH ONE-STEP MAJORITY LOGIC DECODABLE CODES FOR MULTIPLE BIT ERROR CORRECTIONS WITH LOW LATENCY

(71) Applicant: Avalanche Technology, Inc., Fremont, CA (US)

(72) Inventors: Siamack NEMAZIE, Los Altos Hills, CA (US); Ravishankar TADEPALLI, Fremont, CA (US); Mehdi ASNAASHARI, Danville, CA (US)

(73) Assignee: Avalanche Technology, Inc., Fremont, CA (US)

(21) Appl. No.: 14/217,268

(22) Filed: Mar. 17, 2014

Related U.S. Application Data
(60) Provisional application No. 61/794,934, filed on Mar. 15, 2013.

(51) Int. Cl. G06F 11/10

(52) U.S. Cl. CPC G06F 11/1008
USPC 714/6.1

(57) ABSTRACT

A memory module includes a bridge controller having a first interface and a second interface. The first interface receives commands and data from a host and the second interface is coupled to one or more memory components. The bridge controller performs multiple-bit error detection and correction on data stored in the one or more memory components.

### CROSS REFERENCE TO RELATED APPLICATIONS

This application claims priority to U.S. Provisional Patent Application No. 61/794,934, filed on Mar. 15, 2013, by Nemazie et al., entitled “A Dual Data Rate Bridge Controller with One-Step Majority Logic Decodable Codes for Multiple Bit Error Corrections with Low Latency”.

### FIELD OF THE INVENTION

The invention relates generally to writing and reading of magnetic random access memory (MRAM) and particularly to writing and reading of MRAM with high bit error correction techniques and low latency.

### BACKGROUND OF THE INVENTION

### Description of Prior Art

Memories are commonly protected by error correction codes (ECCs) to avoid data corruption. These codes are generally single-bit error correction due to their simplicity and low latency. Multiple-bit error correction codes are difficult to implement and consume many clocks of latency thereby degrading the overall system performance. One step majority logic decoding (OSMLD) enables multiple bit error corrections with low to medium complexity by decreasing the code rate used by an error correction code unit. When error correction codes are implemented, write data is typically encoded using a generator polynomial. Check bits generated during encoding process are stored in the memory array along with the data bits. While reading from the memory, data and the check bits are decoded to correct any errors that occurred in the memory. There exists many implementations of error correction code units. Some of these implementations use serial decoding thereby incurring high latency and others use a parallel decoding to reduce the latency.

In current memory subsystems, volatile memory, like Dynamic Random Access memory (DRAM), are typically mounted on a memory module which interfaces to a host or (“Central Processing Unit (CPU)”) through a memory controller. These memory modules generally have data bus widths to communicate with the outside world, most common of which are 64-bit and 128 bit widths. These memory modules also support memory arrays for the check bits that support error correcting codes with 1 bit error correction or a 2-bit error detection. The process of encoding and decoding of error correction codes is implemented in host memory controller and the memory subsystem typically provides the storage capabilities.

Magnetic random access memory (MRAM) is one of the next generations of non-volatile memory currently under development. It interfaces to the host using multiple standard protocols like Dual Data rate (DDR) and serial protocol interface (SPI) as per the specifications defined by industry standard groups like JEDEC.

Memory modules provide a wide range of configurable options to support timing parameters from different vendors. These configuration options are provided to the host memory controller by a Serial Presence Detect (SPD) interface by storing configuration parameters in an EEPROM component on the memory module.

As technology scales to nanometer granularity, induced errors will impact multiple memory bits. At lower geometries, thus, there is a need to correct multiple data bits. It is well understood and known that there exists many different types of memory components with dual data rate interface and having different error characteristics.

Thus, the need arises for reading and writing to memories with high density and high-bit error rates while meeting industry standard.

### SUMMARY OF THE INVENTION

To overcome the limitations in the prior art described above, and to overcome other limitations that will become apparent upon reading and understanding the present specification, the present invention discloses different methods for multiple bit error tolerant memory modules that can be integrated into current and next generation memory subsystems.

Briefly, an embodiment and method of the invention includes a memory module includes a bridge controller having a first interface and a second interface. The first interface receives commands and data from a host and the second interface is coupled to one or more memory components. The bridge controller performs multiple-bit error detection and correction on data stored in the one or more memory components.

These and other objects and advantages of the invention will no doubt become apparent to those skilled in the art after having read the following detailed description of the various embodiments illustrated in the several figures of the drawing.

### IN THE DRAWINGS

FIG. 1 shows a non-volatile memory subsystem 100, in accordance with an embodiment of the present invention.

FIG. 2 shows further details of the Bridge controller element 200, in accordance with an embodiment of the present invention.

FIG. 3 shows a Data format element 500, in accordance with an embodiment of the present invention.

FIG. 4 shows a Read timing diagram, in accordance with an embodiment of the present invention.

FIG. 5 shows a Burst Read timing diagram, in accordance with an embodiment of the present invention.

FIG. 6 shows a Write timing diagram, in accordance with an embodiment of the present invention.

FIG. 7 shows a Burst Write timing diagram, in accordance with an embodiment of the present invention.

FIG. 8 shows Table 1 which shows Data Bits, Checks Bits, No. of Errors Correctable and Total Bits for each class of codes, C1-C7.

### DETAILED DESCRIPTION OF VARIOUS EMBODIMENTS

In the following description of the embodiments, reference is made to the accompanying drawings that form a part hereof, and in which is shown by way of illustration of the specific embodiments in which the invention may be practiced. It is to be understood that other embodiments may be utilized because structural changes may be made without departing from the scope of the present invention. It should be noted that the figures discussed herein are not drawn to scale and thicknesses of lines are not indicative of actual sizes.

In accordance with an embodiment of the invention, a memory module refers to an array of memory components, passive and active components and a bridge controller with an ability to process the data stream. Each memory component stores the data without any modifications to the input data stream and includes core and peripheral circuits, row and column decoders, sense amplifiers and the like. Bridge controller can be either a programmable device or an application specific integrated circuit.

Various embodiments of the invention include methods and apparatus can be extended to non-volatile memories, an example, among many others too numerous to list, is magnetic random access memory (MRAM). For the purpose of error correction when reading and writing data to non-volatile memory, several error correcting codes based, such as those based on Euclidean and projection geometries that are one-step majority logic decodable codes are employed in embodiments and methods of the invention.

Error correction is effectuated by removing the redundancy that accompanies data as a part of the input data stream to a bridge controller. Additionally, latency is reduced by parallelization and segmentation of the input data stream. Moreover, the industry-set standard of Dual Data Rate (DDR) Synchronous Dynamic Random Access Memory (SDRAM) Specification, by JEDEC, is met.

A memory module that can tolerate multi-bit errors without incurring little to higher additional latency makes up one or more of the embodiments of the invention.

In accordance with an embodiment of the invention, a memory module element includes a bridge controller element having circuits that enhance the capabilities of the memory module. In accordance with an embodiment of the invention, bridge controller element implements a multi-bit error correction with low latency for transfers between a host and one or more memory components of the memory module. The operation and timing parameter requirements of the memory module element as specified by the industry standard, such as the DDR SDRAM Specification, are met.

Referring now to FIG. 1, a memory module element (also known herein as “non-volatile memory sub-system”) 100 is shown in accordance with an embodiment of the invention. Relevant components of the memory module element 100 are shown, in FIG. 1, to comprise a bridge controller element 200, multiple memory components, such as memory components 106, configuration memory element 116 and the interfaces 104, 108, 112, and 114.

The controller element 200 is shown coupled to the memory components 106 through the definition element 108. The controller element 200 is also shown coupled to the memory element 116 through the definition element 114 and it is shown to generate output and couple the same onto the interface 114. The controller element 200 further receives information through the interface 104.

In an exemplary embodiment, interface 104 is compliant with the dual data rate (DDR) specification as specified by organizations like JEDEC for data transfers between the element 100 and the host memory controller with data widths of 64, 72, 128, and 144 bits on each edge of the input clock. Interface 112 is I2C rate protocol for transfer of configuration information—between bridge controller element 200 and the host memory controller. Interface 114 is I2C rate protocol for transfer of configuration information between bridge controller element 200 and the configuration memory component.

Interface 108 is dual data rate protocol and may operate as per the timings paramaters as specified by organizations like JEDEC for data transfers between bridge controller element 200 and the memory components 106. Each memory components 106, generally supports data widths of 4, 8 or 16 bits. All of the memory components 106 share a common control and address bus and a concatenated data bus on the interface 108.

Configuration memory element 116 is a non-volatile memory component and is generally practiced using an Electrically Erasable Programmable Read only memory (EEPROM) or a MRAM. It defines all of the timing parameters and the configuration of the memory module 100. The configuration memory element 116 indicates the timing parameters for the memory components 106 and the controller 200 operates within these parameters. The controller 200 remains invisible to the host in that the timing requirements of the DDR SDRAM Specification for transferring data to memory are met despite the presence of the controller. Accordingly, the host remains ignorant of which device it is actually communicating with. From the host's perspective, it is under the impression that it is sending data to memory and/or reading data from memory, i.e. memory components 106.

The memory components 106, in FIG. 1, are shown coupled to the bridge controller element 200 through the interface 108. The bridge controller element 200 is shown coupled to the configuration memory element 116 through the interface 114. The bridge controller element 200 is further shown coupled to the interfaces 104 and 112. The interfaces 104 and 112, in accordance with an embodiment of the invention, are coupled to a host that is in communication with the memory module 100.

In some embodiments of the invention, the memory components 106 are MRAM or solid state memory or any kind of volatile, such as dynamic random access memory (DRAM) or non-volatile memory. While the memory components 106 is shown to include more than one memory component, any number of memory components may be employed including one memory components.

In some embodiments of the invention, the memory module 100 may include more than one interface 108.

In one embodiment of the invention, input data received on interface 104 is encoded using a OSMLD code and presented, in its encoded form, on the interface 108 to multiple memory components 106. Any request for data from any one of the memory components 106 received on interface 108 are transferred to interface 104 by the bridge controller element 200.

Data received from the memory components 106 are decoded using the OSMLD code and corrected for errors with very low latency, adhere go the timing parameters, specified by DDR SDRAM Specification, before data is transferred on interface 104 by the bridge controller element 200.

OSMLD encoding/decoding is employed in some of the embodiments of the invention due to its speed as a result of low code rates. This fast encoding and decoding makes up for the difference in the timing parameters of memory components 106 and the requirements of the DDR SDRAM Specification-compliant interface 104. In cases where the interface 108 is non-DDR SDRAM Specification-compliant, the element 200 advantageously, higher bit error correction is realized due to the speed of the OSMLD encoding/decoding. In cases where both interfaces 104 and 108 are DDR SDRAM Specification-compliant, there is advantageously no adverse performance impact on the memory module element 100. FIG. 8 shows Table 1 which shows 1 shows Data Bits, Checks Bits, No. of Errors Correctable and Total Bits for each class of codes, C1-C7. Effectively, the error correction capabilities of the classes C1-C7 of one-step majority logic decodable (OSMLD) codes.

As can be seen, codes C2, C3, C4, C5, C6 and C7, have a capability of correcting multiple-bit errors. Code C3 is derived from code C2 by shortening the input data to the encoder. Similarly, codes C5 and C6 are derived from the code C4 by shortening the input data. It is well understood and known that OSMLD codes, based on different sets, have a low latency for error corrections.

FIG. 2 shows further details of the element 200 of FIG. 1. The element 200 is shown to include a DDR-A interface controller 202. Referring again to FIG. 2, further details of the bridge controller element 200 is shown to include a DDR-A interface controller 202, a OSMLD encoder wrapper element 204, and OSMLD decoder wrapper element 208, and a DDR-B interface controller 206.

The element 204 is shown to include single error correction-double error correction (SEC-DED) decoder 201, data unpacker 203, and a number of OSMLD encoders 205, in accordance with an embodiment of the invention. The element 208 is shown to include single SEC-DED decoder 207, data upacker 209, and a number of OSMLD decoders 211, in accordance with an embodiment of the invention.

Relevant components of the bridge controller element 200 in the encoding data path include the element 202, the element 204 and the element 206. Relevant components of the bridge controller element 200 in the encoding data path include the element 206, the element 208, the element 202, and the interfaces 104, 108, 112 and 114, and 116.

The decoder 201 is shown coupled to the controller element 202 and the data unpacker 203. The data unpacker is further shown coupled to each of the encoders 207, which are shown coupled to the controller element 206. Similarly, the decoder 207 is shown coupled to the controller element 202 and the data packer 209. The data packer is further shown coupled to each of the decoders 211, which are shown coupled to the controller element 206.

The decoder 201 receives data from the controller element 202 and decodes it using one of the SEC-DED algorithms. It removes the check bits and sends the decoded data bits to the data unpacker 203. The data unpacker 203 orders the data into segments, per the OSMLD encoding algorithm place. The data unpacker 203 sends the unpacked data to each of the encoders 205, which encode the data received from the data unpacker 203, per the OSMLD algorithm. The OSMLD encoded data is sent by the encoders 205 to the controller element 206.

Each of the decoders 211 received data from the controller element 206 and decode the data for use by the data packer 209. The data packer 209 re-ordering the received data for use by the encoder 207, which encodes the data and sends the encoded data to the controller element 202.

Each of the encoders 205 can employ different OSMLD code, correspondingly, each of the decoders 211 can employ different OSMLD code.

In alternative embodiments, the data on the interface 104 may not include SEC-DED error correction, in which case, the decoder 201 and encoder 207 are unnecessary.

Input data received on interface 104, is encoded by bridge controller element 200 per code C5 in FIG. 8 Table 1. Total bits including data bits and check bits per sample C5 are transferred to the memory components 106 on the interface 108. During decoding, the total bits including data bits and check bits received on interface 108 from the memory components 106 are corrected for multiple-bit errors of the data bits but with low latency and transferred onto the interface 104.

It is well understood and known to those skilled in the art, that input data received on interface 104 can be encoded by bridge controller element 200 after segmenting the input data to codes C2 and C3, shown in Table 1, without any additional latency for segmentation. Total bits comprising of data bits and check bits per codes C2 and C3 are transferred to the memory components 106 on the interface 108. During decoding, total bits received on interface 108 from memory components 106 are segmented per codes C2 and C3 and each code is corrected for multiple-bit errors of the corresponding data bits with low latency and transferred onto the interface 104.

The memory module element 100 advantageously replaces the dual in-line memory module (DIMM) of prior art.

In one embodiment of the invention, input data received on interface 104 is processed in various steps to provide low latency multiple-bit error correction capability. Interface controller 202 interfaces to the host using the interface 104.

Input data on the interface 104 is received in multiple clocks by the controller 202. Data is received on the rising edge as well as the falling edge of the clock by the controller 202. This data is accumulated over various clocks, in part or in whole, and the OSMLD coding algorithm is applied to the accumulated data. The accumulation of data over various clocks matches the data lengths supported by the wrapper element 204.

It is understood that the interfaces 104 and 108 can each be compliant with any version of the DDR SDRAM Specification, such as but not limited to, DDR3 or DDR4.

In some embodiments, there are more than one of each of the elements 204 and 208 and more than one controller 206. The interface 116 enables each of the elements 204 and 208 and controller 206. The controller 202 includes port multipliers functionality, i.e. interfaces to different instances of the elements 204 and 208 and controller 206. The controller 202 and the controller 206 may each include memory registers or buffers. Memory buffers and registers provide isolation of memory components 106 from the host.

In the embodiment of FIG. 2, the write data path is across the controller 202, the element 204 and the controller 206, the write control path is across controllers 202 and 206. The read data path is across controller 206, element 208 and controller 202 while the read control path is across controllers 202 and 206.

As can be appreciated, the controller 202 is designed to meet the DDR SDRAM Specification timing requirements, similarly, the controller 206 is designed to meet the DDR SDRAM Specification timing requirements and the configuration parameters from interface definition 114. Some of the configuration parameters include but not limited are the timing parameters for DDR-A interface 104, DDR-B interface 108, error correction capabilities of bridge controller 200 and the characteristics of memory element 106.

Now referring to OSMLD encoder wrapper element 204, in alternative embodiments of the invention, is a Single Error Correction Double Error Detection (SECDED) decoder thereby correcting any single bit errors on the data bits.

The input data from received on the interface 104, by the controller 202, defines the requirement for SEC-DED coding, or not. In embodiments where data and check bits, according to the SEC-DED algorithm, are received from the interface and there is no need to store the received check bits, the functionality of the decoder 201 and encoder 207 is unnecessary.

Each of the encoders 205 is capable of encoding data bits to produce check bits for multiple bit error corrections with very low latency. The requirements of the encoders 205 are derived from the error correction capabilities required for the memory elements 106, the number of memory elements in the memory module 100 for the check bits, latencies that can be tolerated by the interfaces 104 and 108.

The latency of the encoders 205 are within the confines of the difference in the timing of the interfaces 104 and 108. The relationship between the error correction capabilities, ratio of the data bits to the check bits and the latencies for the additional processing to generate the check bits are known to those in the art.

The controller 206 as shown in FIG. 2, receives data bits from the element 204, and control and command information from the controller 202 to be transferred to memory elements 106 on the MRAM interface 108. The requirements on the controller 206 are derived from the interface 108 and the format of the control information received from the controller 202.

In some embodiments of the invention, some of the commands coming through the interface 104 can be masked by the controller 206 therefore not reaching the memory components 106.

In the exemplary embodiment of the invention, during the write operation, the controller 206 converts data bits received on every positive edge of the clock to be split into data bits on both the positive and negative edge of the clock on the interface 108. The controller 206 transfers commands, like bank activation, precharge of the banks, read or write of memory contents, transfer of row and column address, and masks the commands that are not required by the memory components 106. Examples of such unnecessary commands include refresh command to the memory components 106.

In accordance with a method and embodiment of the invention, during a write operation, the OSMLD encoded data is interleaved to reduce the impact of burst errors on a single data segment.

In response to a read command, received by the controller 202, the controller 206 transfers data and checks bits received from the memory components to the OSMLD decoder wrapper element 208 for further processing after de-interleaving the data bits and the check bits.

On the decoding path, for each of the encoder 205, there exists a corresponding decoder 211 with an ability to correct multiple-bit errors based on the check bits generated by the encoders 205. Decoded and corrected data from the decoder 211 is packed and SEC-DED-encoded to reverse the processes implemented in element 204 and transferred to controller 202. The host reads the data from the controller 202 coupled onto the interface 104 after a fixed latency. It is expected that data be ready in the controller 202 after this fixed latency period.

With reference to FIG. 3, in an exemplary embodiment of the invention, data format element 500 indicates the format of the data received from the host after processing by the controller 202. Data format element 500 comprises of data bits and error control (also referred to here as “check”) bits encoded per the SEC-DEDalgorithm. Data received from the memory elements 106 are presented to the host in the format of data format element 500 after the addition of error control bits. Data format element 502 represents data without error control bits in data format element 500. Data format element 504 represents the unpacked format to be encoded by the OSMLD encoder wrapper element 204 and the unpacked format after decoding by the OSMLD decoder wrapper element 208. Data format element 506 represents the output of OSMLD encoder wrapper element 202 and input of the OSMLD decoder wrapper element 208 with the addition of check bits for each data segment. Data format element 508 represents interleaved data transmitted and received by the controller 206 to and from the memory components 106. During the decoding process, the flow of the foregoing operations is reversed.

Segmenting the data, such as shown by data segment element 506, in FIG. 3, helps reduce latency. In fact, the more segments, the lower the latency. But the increase in segments has the effect of additional overhead, i.e. check bits.

Now referring to FIG. 8, Table 1, length K in data format element 502 corresponds to code C5 for data bits of 128. Lengths K1, K2 in data format element 504 correspond to code C2 for data bits. “K’, “R”, “M”, and “N” represent lengths of data and/or check bits as well as zero-padded data. Length K3 in data format element 504 corresponds to code C2 for data bits. Lengths K1, K2 and K3 in data format element 506 are the same as the lengths K1, K2 and K3 in data format element 504. Lengths R1, R2 and R3 in data format element 506 are the additional check bits for each data segment and corresponds to check bits as per codes C2 and C3 of Table 1. Lengths N1, N2 and N3 in data format element 508 represents the total bits corresponding to codes C2 and C3 in Table 1. Length M in data format element 508 represents the number of bits padded with ‘0’ to match with the width of the memory components 106.

In the embodiment of the invention, it is expected that the total latency incurred from the issuance of a command from the host to the availability of the data on the interface 104 is fixed during the configuration of the memory module 100 and adheres to the corresponding range of values defined in the DDR SDRAM Specification. All the latencies incurred by the individual elements and the access times of the memory components 106 cumulatively are equal to the total latency expected by the host.

Now referring to FIG. 4 a timing diagram is shown of relevant signals and their behavior during a read operation. At 400, the behavior of a clocking signal is shown relative to the DDR-A interface's behavior, at 410 in FIG. 4, and the DDR-B interface's behavior at 420. The bridge controller element 200, shown in FIG. 1, receives the clocking signal shown at 400 in FIG. 4. At 410, essentially the relationship between the command and data bus components of the DDR-A interface 104 and the various configuration parameters is shown. Examples of timing parameters include, without limitation, timing parameter 401 tRCD_A (RAS to CAS delay on interface 104) and timing parameter 402 tRL_A (Read latency from activate command to availability of the data to the host memory controller). The read latency (tRL_A) is a combination of tAL_A (posted additive CAS latency as seen by bridge controller) and tCL_A (CAS latency for read command to data availability to the host memory controller). At 420, the relationship between the command and data bus components of the DDR-B interface 108 and the various timing parameters are shown. Examples of these timing parameters include, but are not limited to, tRCD_B (RAS to CAS delay on interface 108) and timing parameter 406 tRL_B (Read latency from activate command to availability of the data to the DDR bridge controller from the MRAM element 106) which is a combination of tAL_B (posted additive CAS latency timing parameter for each of memory components 106) and tCL_B (CAS latency for read command to data availability to the Bridge controller from the memory components 106). The timing parameters like tRCD_B, tRL_B, tAL_B, tCL_B need or need not adhere to requirements of the DDR SDRAM Specification.

In an exemplary embodiment of the invention, the difference in the latencies between timing parameter 406, tRL_B and timing parameter 401, tRL_A and the ability to indicate different timing parameters to host memory controller, controller 200 and memory components 106 are used to bridge interface 104 and interface 108 and provide multiple bit error tolerance using OSMLD codes. It is well known and understood in the art that there exists multiple timing parameters for write timing, burst read timing, burst write timing and total cycle time between successive commands from the host memory controller. Some of them are tRRD (minimum row active to row active delay), tCCD (minimum CAS to CAS delay between successive read and write commands), tWR (Write recovery time), tCWL (CAS write latency), tRP (Row precharge time) and the like. As per the JEDEC specification, some of the command codes include read with precharge and write with precharge. For non-volatile memory element 106, precharge operation may not be utilized. This provides additional clocks that can be utilized to implement higher multi-bit error correcting OSMLD codes incurring higher latency in the bridge controller 200. In FIGS. 5-7, it is indicated usage of some timing parameters to support multiple operations beyond single reads by the bridge controller element 200. It is expected that OSMLD encoding latency incurred during writes can be similarly recovered during subsequent read cycles or during minimum cycle timing parameters of the interface 104. In addition to configurability in the timing parameters, any other techniques to change the difference in the latency are considered as part of the scope of the invention.

FIG. 5 is analogous to FIG. 4 except that read command code 413 and read command 414 are issued to different columns of the same row for the memory element 106 with a timing parameter 411 (CAS to CAS delay, tCCD_A). Each of the read commands 413 and 414 are issued on DDR-interface 108 with a constant delay as read command codes 416 and 417. Since OSMLD decoding scheme does not incur different latency based on the column being accessed and timing parameter 415 tRL_B (read latency from read command to data availability on interface 108) is fixed, timing parameter 412 tRL_A (read latency from read command to data availability on interface 104) is fixed and adheres to the timing parameters as defined in the DDR SDRAM Specification for the interface 104.

FIG. 6 is analogous to FIG. 4 except that the active command code 603 is followed by write command code 604. Write data on DDR interface 104 is issued after timing parameter 602. Active command 603 and write command 604 on the interface 104 are delay shifted as command codes 607 and 608 on the interface 108. Each of the data received on either edge of the clock timing 400 is encoded and presented as write data on the interface 108 with timing parameter 606. The timing parameter 601 for Active command 603 to write column 604 with posted CAS latency tAL_A, write latency tWL_A as depicted by timing parameter 602 form part of the DDR SDRAM Specification.

FIG. 7 is analogous to FIG. 5 except that the write command 613 and write command 614 are issued to different columns of the same row for the memory components 106 with a timing parameter 611 (CAS to CAS delay, tCCD_A). Each of the write commands 613 and 614 are issued on interface 108 with a constant delay as write command codes 617 and 618. OSMLD encoding scheme does not incur different latencies for different columns being accessed and the timing parameter 616 tWL_B (write latency from write command to write data availability on interface 108) is fixed and has similar value as write latency timing parameter 612. Cumulative value of the latency between command on interface 104 and interface 108 and OSMLD encoding latency is lower than the timing parameter 611 (CAS to CAS delay, tCCD_A). With timing parameter tCCD_A greater than encoding latency and command delay time, another write command 614 can be issued without impacting the operation of the interface 104 per the DDR SDRAM Specification.

Although the invention has been described in terms of specific embodiments, it is anticipated that alterations and modifications thereof will no doubt become apparent to those more skilled in the art. It is therefore intended that the following claims be interpreted as covering all such alterations and modification as fall within the true spirit and scope of the invention.

What is claimed is:

1. A memory module comprising:
a bridge controller having a first interface and a second interface, the first interface responsive to commands and data from a host, the second interface coupled to one or more memory components,
wherein the bridge controller is operable to perform multiple-bit error detection and correction on data stored in the one or more memory components.

2. The memory module of claim 1, wherein the bridge controller is responsive to a read command from the host and is operable to read the data from the one or more memory components, detect and correct the multiple bit errors, and communicate the corrected data to the host, the bridge controller remaining invisible to the host.

3. The memory module of claim 1, wherein the timing of data being available to the one or more memory components from the host being the equivalent timing of data from the host to the memory components through the bridge controller.

4. The memory module of claim 1, wherein the memory components are magnetic random access memory (MRAM) or dynamic random access memory (DRAM).

5. The memory module of claim 1, wherein the first interface is compliant with the DDR SDRAM Specification.

6. The memory module of claim 5, wherein the first interface is compliant with any versions of the DDR SDRAM Specification.

7. The memory module of claim 1, wherein the second interface is compliant with the DDR SDRAM Specification.
